(19) United States
(12) Patent Application Publication
(10) Pub. No.: US 2025/0278419 A1
(43) Pub. Date: Sep. 4, 2025

(54) ENSEMBLE OF VECTOR AND GRAPH BASED EMBEDDINGS FOR LARGE LANGUAGE PROMPT AUGMENTATION

(71) Applicant: Salesforce, Inc., San Francisco, CA (US)

(72) Inventors: Phil Mui, San Francisco, CA (US); Shafiq Rayhan Joty, San Francisco, CA (US)

(21) Appl. No.: 19/068,993

(22) Filed: Mar. 3, 2025

Related U.S. Application Data
(60) Provisional application No. 63/561,203, filed on Mar. 4, 2024.

(51) Int. Cl. G06F 16/3329; G06F 16/901; G06F 40/295

(52) U.S. Cl. CPC G06F 16/33295; G06F 16/9024; G06F 40/295

(57) ABSTRACT

Methods, systems, apparatuses, devices, and computer program products are described. A system may obtain a set of documents for input into a query response system, generate a set of vector embeddings based on the set of documents and a semantic vector augmentation pipeline, and generate a set of knowledge graphs based on the set of documents and a knowledge graph augmentation pipeline, where each knowledge graph includes a set of multiple knowledge graph triplets. The system may receive a user query and augment the user query to generate an augmented prompt using at least one or more vector embeddings from the set of vector embeddings and one or more knowledge graph triplets from the set of knowledge graphs. The system may provide, to a large language model (LLM), the augmented prompt as an input and may receive, as an output of the LLM, a response to the augmented prompt.

### CROSS REFERENCE

The present application for patent claims priority to and the benefit of U.S. Provisional Patent Application No. 63/561,203 by Mui et al., entitled “ENSEMBLE OF VECTOR AND GRAPH BASED EMBEDDINGS FOR LARGE LANGUAGE PROMPT AUGMENTATION,” filed Mar. 4, 2024, assigned to the assignee hereof, and expressly incorporated by reference in its entirety herein.

### FIELD OF TECHNOLOGY

The present disclosure relates generally to database systems and data processing and more specifically to an ensemble of vector and graph based embeddings for large language prompt augmentation.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

### BRIEF DESCRIPTION OF THE DRAWINGS

FIG. 1 illustrates an example of a system for data processing that supports an ensemble of vector and graph based embeddings for large language prompt augmentation in accordance with aspects of the present disclosure.

FIG. 2 shows an example of a computing architecture that supports an ensemble of vector and graph based embeddings for large language prompt augmentation in accordance with aspects of the present disclosure.

FIG. 3 shows an example of a computing architecture that supports an ensemble of vector and graph based embeddings for large language prompt augmentation in accordance with aspects of the present disclosure.

FIG. 4 shows a block diagram of an apparatus that supports an ensemble of vector and graph based embeddings for large language prompt augmentation in accordance with aspects of the present disclosure.

FIG. 5 shows a block diagram of a query and answer manager that supports an ensemble of vector and graph based embeddings for large language prompt augmentation in accordance with aspects of the present disclosure.

FIG. 6 shows a diagram of a system including a device that supports an ensemble of vector and graph based embeddings for large language prompt augmentation in accordance with aspects of the present disclosure.

FIGS. 7 and 8 show flowcharts illustrating methods that support ensembles of vector and graph based embeddings for large language prompt augmentation in accordance with aspects of the present disclosure.

### DETAILED DESCRIPTION

Question and Answer (QA) systems, such as those that leverage large language models (LLMs), are designed to provide accurate and relevant responses to user queries, often leveraging complex algorithms and vast databases of information. However, in some cases, these systems may fail to identify accurate and relevant information or determine the true intent behind user queries. Such difficulties may result in responses that are inaccurate, not fully satisfying to the user, or both. Developing a QA system that can effectively handle complex or ambiguous queries, accurately identify relevant information, and generate responses that are both accurate and satisfying to a user may improve the efficiency of the QA system.

Techniques described herein support user query augmentation to “ground” a query to a knowledge base for a QA system. For example, “grounding” a query to a knowledge base (e.g., a database, a data source, an aggregation of documents or other information relevant to a system, organization, or topic) may involve determining data objects, documents, portions of documents, or other relevant information stored for the knowledge base that are associated with the user query. The techniques described herein leverage two pipelines that work to encode the knowledge base for use in prompt (e.g., query) augmentation. A first pipeline utilizes semantic vector augmentation, a process that involves generating vector embeddings for a set of unstructured data (e.g., a set of documents). A second pipeline utilizes knowledge graph augmentation, a process that involves the extraction of triplets from a set of data (e.g., the unstructured data, structured data, or both) and the storage of the triplets in a graph database. A triplet may be an example of a data object or unit of information that includes three elements: a subject (or head) element, a predicate (or relation) element, and an object (or tail) element. In some examples, the graph database may store the triplets as nodes, edges, properties, or a combination thereof in a virtual graph structure. A system (e.g., the QA system) may generate the vector embeddings, knowledge triplets, or both for a set of documents using batch processing, as background operations, or otherwise implementing efficient processing to ensure the pipelines for encoding the knowledge base maintain processing resource availability for other operations. In some examples, the system may update the vector embeddings, the knowledge triplets, or both in near-realtime or using batch processing as new or updated documents are added to the knowledge base.

By implementing the two pipelines, the system may use the same data to generate two different types of embeddings or encodings that support prompt augmentation. When a user query is received at the QA system, the system may identify a set of vectors, from the vector embeddings, that are similar to—or otherwise associated with—the user query (e.g., using one or more vector similarity techniques), a set of knowledge graph triplets (which may be vectorized) that are similar to—or otherwise associated with—the user query, or both. The system may use the set of vectors, the set of knowledge graph triplets, or both to augment the user query and may input the augmented user query (or one or more values representing the augmented user query) into an LLM. Thus, the two pipelines are ensembled (e.g., the results of the pipelines are combined or otherwise aggregated) and used to augment a user query with knowledge base-specific information. The LLM may output a relatively more accurate answer to the query based on the additional contextual information provided by the augmentation. In some examples, the multiple pipelines may combine multiple machine learning models to obtain better predictive performance than could be obtained from any of the constituent models. The LLM's accuracy is enhanced as it is grounded by the knowledge graph and the vector embeddings (e.g., word embeddings or other generated vectors). The techniques described herein for query augmentation may support efficient processing of queries by grounding them in a knowledge base, thereby enhancing the accuracy of the LLM and the QA system. The LLM may process relatively fewer queries in order to provide an accurate and satisfying response to a user, reducing the processing overhead associated with running the LLM and outputting results. These and other techniques are described in further detail with respect to the figures.

Aspects of the disclosure are initially described in the context of a data processing system. Aspects of the disclosure are further described in the context of architecture diagrams that support pipelines for encoding documents for query augmentation and a query augmentation process. Aspects of the disclosure are further illustrated by and described with reference to apparatus diagrams, system diagrams, and flowcharts that relate to an ensemble of vector and graph based embeddings for large language prompt augmentation.

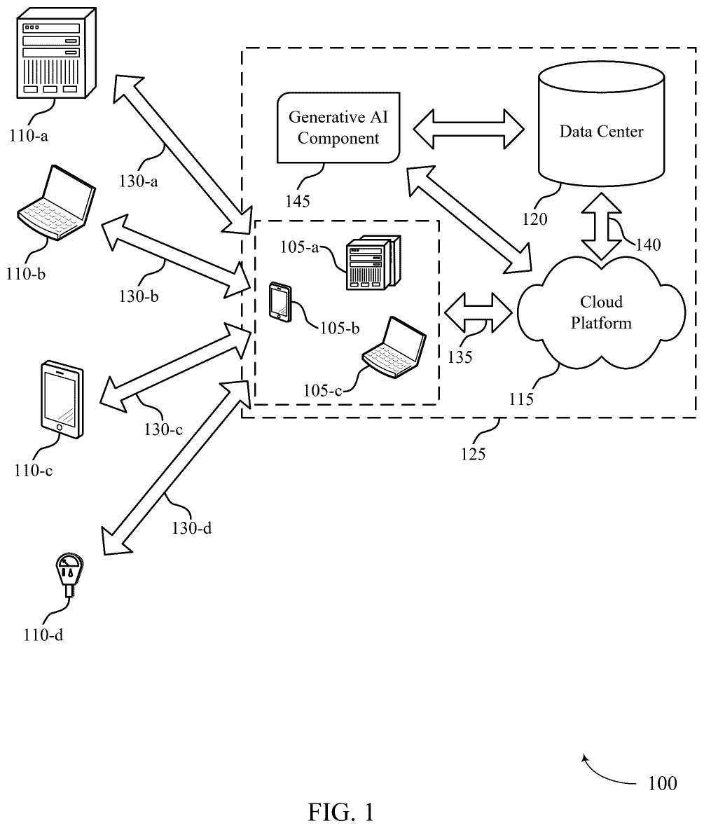

FIG. 1 illustrates an example of a system 100 for data processing that supports an ensemble of vector and graph based embeddings for large language prompt augmentation in accordance with aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135 and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of an LLM, such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with one another, or a combination of both. Furthermore, the AI technologies may be merged in a variety of implementations, for example, by bagging, boosting, stacking, etc. the AI technologies.

The cloud platform 115, the subsystem 125, or both may support various services for contact 110 and/or cloud client 105 interaction. For example, the cloud platform 115 may support a customer service chat bot (e.g., an example or component of a QA system) that a cloud client 105 may implement or leverage to support interactions 130 with the contacts 110. In some examples, these chat bots may leverage generative AI (e.g., the generative AI component 145) and/or LLM techniques to support these interactions. Such systems may be designed to provide accurate and relevant responses to user queries, often leveraging complex algorithms and vast databases of information (e.g., stored at a data center 120 or other data management system or service). However, a persistent challenge for such systems is the ability to handle complex or ambiguous queries effectively. Other QA systems may struggle to identify the relevant information or understand the true intent behind user queries. This difficulty may result in responses that are inaccurate, not fully satisfying to the user, or both. Some systems may implement RAG techniques to attempt to improve the accuracy of query responses. However, RAG processes may retrieve documents that are not relevant for the current user query based on a limited or incomplete understanding of the document contents. For example, the RAG processes may retrieve documents that use similar words as the query but may fail to determine how these words correspond to underlying data objects in a database, relationships between data objects or entities, or other important connections. Accordingly, such systems may inefficiently search for relevant documents that fail to provide the proper context for an LLM, increasing a processing overhead of the QA system without improving an accuracy of the answers provided by the QA system. In contrast, developing a QA system that can effectively handle complex or ambiguous queries, accurately identify relevant information, and generate responses that are both accurate and satisfying to a user may improve the efficacy and efficiency of the QA system.

Techniques described herein support query augmentation using multiple data pipelines (e.g., multiple data stores or types of data storage from the data center 120) that encode information from a knowledge base using different techniques. For example, the system 100 may use two or more pipelines to encode documents (e.g., any form of information, such as emails, texts, snippets of text, snippets of code, full documents, images, or any other data) of a knowledge base. In some cases, a first pipeline may perform semantic vector generation based on a set of documents that are input to the system 100 (e.g., associated with a knowledge base), and the vectors are stored in a vector store of the data center 120. A second pipeline may perform knowledge graph generation based on the set of documents that are input into the system 100 (e.g., associated with the knowledge base), and vectorized triplets from the knowledge graph may be stored in the same or a different vector store of the data center 120. When a user query is received, similar vector embeddings and similar knowledge graph triplet embeddings are used to augment the user query. By using two different types of encodings of information (e.g., vector embeddings and knowledge graph triplets), the system 100 may improve the query augmentation process and provide more accurate context with the user query as inputs to an LLM. The output provided by the LLM in response to the augmented query may be provided to the user. The multiple pipeline structure for encoding information may improve the accuracy and efficiency of the LLM, reducing a processing overhead associated with the system 100 providing an answer to a user query. For example, improving query augmentation may reduce a quantity of queries to be processed (or a quantity of queries that are updated to clarify a question) at the LLM, reducing a processing overhead associated with running the QA system.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

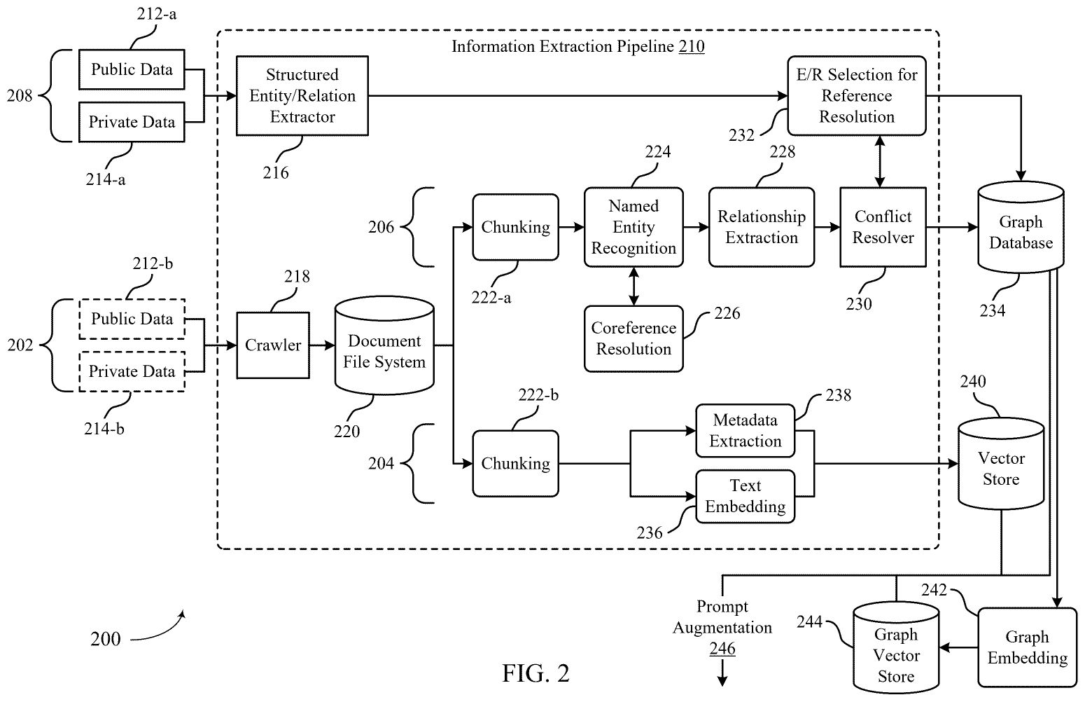

FIG. 2 shows an example of a computing architecture 200 that supports an ensemble of vector and graph based embeddings for large language prompt augmentation in accordance with aspects of the present disclosure. The computing architecture 200 includes various components for information extraction to support prompt augmentation. The computing architecture 200 may represent at least a portion of a computer architecture that supports a QA system as described herein. The computing architecture 200 may support multiple pipelines for encoding information in different forms to support query augmentation (e.g., LLM prompt augmentation). A processing device or system, such as a server, worker server, application server, database server, server cluster, user device, cloud-based service, container, virtual server, or any combination thereof may provide the computing architecture 200.

At 202, the system may receive, retrieve, identify, or otherwise obtain unstructured data (e.g., a set of documents) associated with a knowledge base (e.g., a specific topic, data type or database schema, or goal of the QA system). The unstructured data may include websites, Really Simple Syndication (RSS) feeds, call logs, slack channel feeds, emails, text messages, chat messages, previous queries, or any other information. In some cases, a crawler 218 may obtain the unstructured data (e.g., scraping websites or otherwise identifying the data associated with the knowledge base), and the data may be stored in a document file system 220. The unstructured data may include public data 212-b, private data 214-b, or both.

The unstructured data may be processed by two pipelines (e.g., multiple pipelines within an information extraction pipeline 210) for vector generation. A vector augmentation pipeline 204 (e.g., a first data pipeline) may perform chunking 222-b, text embedding 236, and metadata extraction 238 on the unstructured data. The chunking 222-b may involve determining discrete portions of text from the unstructured data (e.g., the documents) for the text embedding 236, the metadata extraction 238, or both. In some examples, the chunking 222-b may use delimiters, such as periods, line breaks, page breaks, white space, or other logical or implicit delimiters, to separate the unstructured data into distinct chunks (e.g., portions) for processing. The text embedding 236 may embed each chunk of data into a vector space (e.g., an N-dimensional vector space, where N may be any integer value). The text embedding 236 may use any vectorization or embedding technique (e.g., word embedding, phrase embedding) to generate a vector that corresponds to a data chunk. For example, the text embedding 236 may generate an array of values representative of a vector in a vector space that indicates the contents of the data chunk. Additionally, or alternatively, the metadata extraction 238 may involve determining metadata associated with each chunk of data. The vector augmentation pipeline 204 may store the resulting vectors (in some examples, with corresponding metadata) in a vector store 240.

Additionally, or alternative, a knowledge graph augmentation pipeline 206 (e.g., a second data pipeline) may perform chunking 222-a, named entity recognition (NER) 224 (in some examples, with coreference resolution 226), relationship extraction 228, confliction resolution (e.g., via a conflict resolver 230), and knowledge graph generation based on the unstructured data (e.g., the set of documents from the document file system 220). In some examples, the computing architecture 200 may perform a single chunking operation, where the resulting chunks of data are sent through both pipelines. In some other examples, the different pipelines may perform chunking separately, which may possibly result in different chunks of data (e.g., of different sizes, with different delimiters, with different information) being processed via the different pipelines. NER 224 may involve determining one or more named entities within each chunk of data. For example, a named entity may be a user, an identifier, a data object (e.g., a data object stored in a database, such as a multi-tenant database), a specific parameter or value, or any other identifiable entity that is associated with additional contextual meaning (e.g., beyond the definition of the word or words themselves). Coreference resolution 226 may involve resolving entity conflicts or vagueness within a document. For example, if a document states “John ate cereal this morning” and “He then rode the bus,” coreference resolution 226 may involve replacing “He” with “John” in a corresponding knowledge graph triplet. A named entity may be assigned as a subject element for a knowledge graph triplet, an object element of a knowledge graph triplet, or both (e.g., for different triplets). Relationship extraction 228 may determine one or more relationships between identified named entities, for example, based on interaction data (e.g., product purchases, interaction with other subjects) from the documents and/or other structured or unstructured data accessible by the system. A relationship may be assigned as a relationship or predicate element for a knowledge graph triplet, defining the correlation between the subject element and the object element of the knowledge graph triplet. A conflict resolver 230 may resolve conflicts between knowledge graph triplets determined from the unstructured data and knowledge graph triplets determined from structured data. For example, if the conflict resolver 230 determines that a relationship identified from the unstructured data conflicts with a relationship defined in the structured data, the conflict resolver 230 may update or remove the corresponding knowledge graph triplet determined from the unstructured data (e.g., as an anomaly or improper knowledge). The resulting knowledge graph triplets (e.g., subject element, relationship or predicate element, object element) may be stored in graph database 234. In some examples, the subject elements may be stored as nodes in a graph (e.g., a knowledge graph), the object elements may indicate edges between a node representing a subject element and a node representing a corresponding object element, and the relationship elements may indicate weighting of the edges in the graph between the subject elements and the object elements.

Additionally, or alternatively, the knowledge graphs (e.g., formed by a set of knowledge graph triplets at the graph database 234) may be processed to generate vectors and graph embeddings. For example, the computing architecture 200 may perform graph embedding 242 to embed the graph in a vector space (e.g., a vector space defined within a graph vector store 244). The graph embedding 242 may convert the nodes and edges of the graph (e.g., the knowledge graph triplets) into vectors within the vector space, where distances between different vectors may indicate relationships between different named entities or other parameters.

In some cases, the information or entities in the knowledge graphs may be associated with respective timestamps which define the relevancy, liveness, and/or staleness of data. That is, a timestamp may indicate when the corresponding data was collected or identified and/or when the data is to expire. These timestamps may be used by a query and response system to identify relevant data for query augmentation. Thus, if the timestamp indicates that the data is stale, then the corresponding data (e.g., element of a knowledge graph triplet and/or data of a vector) may not be used to augment the user query. Other types of techniques for encoding time with respect to data may be used within the context of the present disclosure. For example, time to live and or age may also be encoded or used in association with graph or vector data. In some cases, the timestamp information may be identified via the metadata extraction 238.

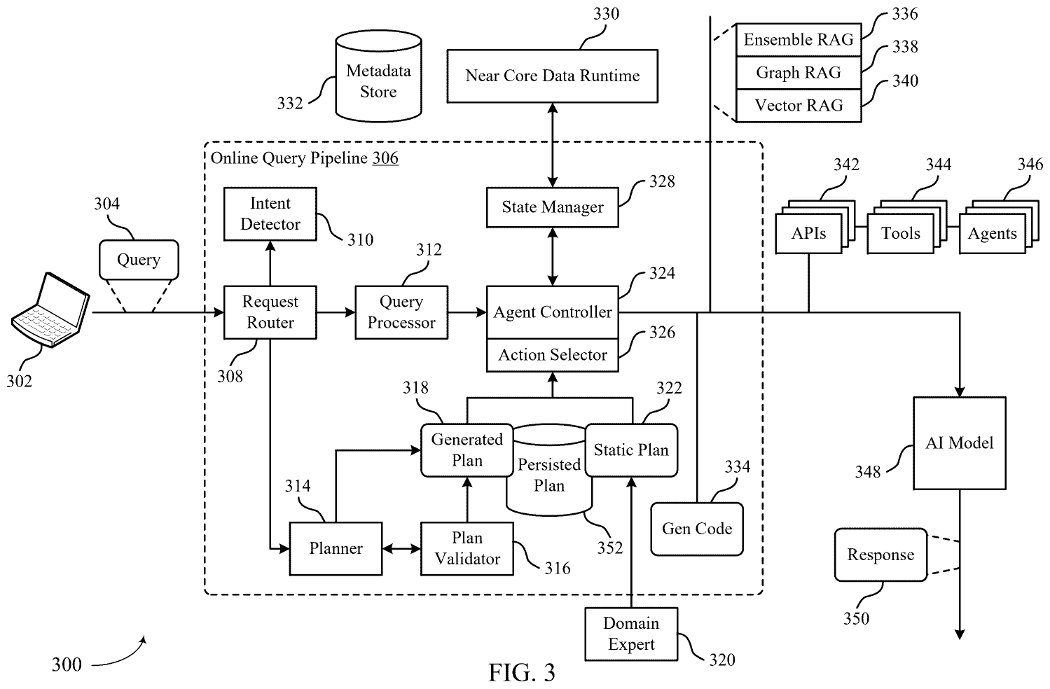

At 208, a structured data pipeline may also process structured data to further support the techniques described herein. The structured data may include public data 212-a, such as data from LinkedIn or other publicly available structured data, and private data 214-a (e.g., data cloud and/or organization/entity data), such as data from private databases or tenant-specific data storage. The structured data may be obtained and processed to extract named entities and relationships from the structured data using a structured entity/relation extractor 216. This data may be used to support the knowledge graph augmentation pipeline 206 by resolving conflicts in the data (e.g., via the conflict resolver 230, a process for entity/relationship selection for reference resolution 232, or both), creating additional knowledge graph triplets (e.g., ground truth triplets) in the graph database 234, or both. This data may be used to support generation of graph embeddings based on relationships (e.g., interactions) between entities. The graph embeddings may be stored in the graph vector store 244. Thus, various data stores with different vector embeddings (and knowledge graphs) based on input data may be generated. Additionally, such data may be used for prompt augmentation 246 as described herein with respect to FIG. 3.

FIG. 3 shows an example of a computing architecture 300 that supports an ensemble of vector and graph based embeddings for large language prompt augmentation in accordance with aspects of the present disclosure. The computing architecture 300 includes various components to support prompt augmentation. The computing architecture 300 may represent at least a portion of a computer architecture that supports a QA system as described herein. The computer architecture may access the data stores of FIG. 2, such as a graph database 234, a vector store 240, a graph vector store 244, or a combination thereof, to support query analysis. For example, the computer architecture may implement a RAG or similar process to retrieve relevant information from the graph database 234, the vector store 240, the graph vector store 244, or a combination thereof to provide contextual information with a query 304 as a prompt (e.g., an augmented prompt) input to an LLM (e.g., an AI model 348).

When a query 304 (e.g., a user query) is received at the QA system (e.g., via a client interface) described herein, the query 304 may be processed by an online query pipeline 306. In some examples, a user operating a user device 302 may input the query 304 as a question to the QA system (e.g., via a QA interface which may be a mobile interface, an application-specific interface, a chat interface, or any combination thereof). The query 304 may be written in natural language, for example, as a question to a chat bot. Additionally, or alternatively, the query 304 may be an example or a component of a prompt to an LLM, such as the AI model 348.

A request router 308 may receive the query 304 and route the query to one or more components of the online query pipeline 306. For example, the request router 308 may send the query 304 to an intent detector 310. The intent detector 310 may process the query 304 to determine (e.g., predict or otherwise detect) the intent of the query 304, for example, using natural language processing (NLP) techniques or other mechanisms.

Additionally, or alternatively, the request router 308 may send the query 304 to a planner 314. The planner 314 may automatically generate a plan (e.g., a generated plan 318) for handling the query 304. For example, the generated plan 318 may define, or otherwise indicate, a set of actions to perform based on the query 304. The actions may involve interactions with a database, interactions with one or more APIs 342, tools 344, agents 346, or any combination thereof. In some examples, a plan validator 316 may analyze the generated plan 318 and determine whether to modify the generated plan 318 (e.g., to improve database interactions, to ensure supported usage of processing resources, or to otherwise validate that the generated plan 318 is supported by the QA system). In some examples, the QA system may store the generated plan 318 at a persisted plan database 352. A stored plan may be retrieved, analyzed, or reused to improve system efficiency. Additionally, or alternatively, a user (e.g., a domain expert 320) may create a static plan 322 for handling the query 304 or for generically handling a set of possible queries. For example, the static plan 322 may be a custom plan based on the query 304 or a universal plan to support one or more queries or types of queries. In some example, the QA system may additionally store the static plan 322 at the persisted plan database 352.

Additionally, or alternatively, the request router 308 may send the query 304 to a query processor 312 (e.g., with an indication of the intent of the query 304). The query processor 312 may process the query 304 (e.g., using NLP or similar techniques) and may send the processed query 304 to an agent controller 324. The agent controller 324 may include, or otherwise communicate with, an action selector 326. The action selector 326 may receive a plan (e.g., a generated plan 318, a static plan 322, or both) and determine a set of actions to perform, an order for performing the actions (e.g., including, in some cases, which actions to perform in sequence and which actions to perform in parallel), or both. The QA system may perform the actions based on the query 304, the plan, and the action selector 326.

In some examples, the agent controller 324 may communicate with a state manager 328. The state manager 328 may manage a runtime state 330 for near Core data. In some cases, the runtime state 330 may additionally depend on metadata from a metadata store 332. In some cases, an action indicated by the action selector 326 may modify a state of data or the runtime state 330, for example, based on the state manager 328.

The agent controller 324 may send the processed query 304 for input into the AI model 348, for example, as a component of a prompt (e.g., a large language prompt). In some cases, the online query pipeline 306 may generate code 334 to further process the query 304 or to modify the prompt. In some cases, one or more APIs 342, tools 344, agents 346, or any combination thereof may modify the prompt.

Additionally, or alternatively, the query 304 may be augmented with one or more aspects of the computing architecture 200 of FIG. 2. For example, the online query pipeline 306 may identify document chunks from the vector store of FIG. 2 based on the similarities between the query 304 (e.g., vectorized query) and the vectors of the vector store (e.g., via vector RAG 340). The online query pipeline 306 may additionally, or alternatively, identify knowledge graph triplets (e.g., vectorized or not) that are similar to the user query (e.g., via graph RAG 338). The online query pipeline 306 may additionally, or alternatively, identify graph embeddings that are similar to or related to the input query (e.g., via graph RAG 338). Such identified information may be “ensembled” or combined together (e.g., via ensemble RAG 336) and/or with the input query 304 to generate an augmented prompt for the AI model 348. In some cases, the AI model 348 may be a component of a system or service hosting, or otherwise supporting, the QA system. The augmented prompt may be passed to an LLM (e.g., the AI model 348) and the LLM may provide a response 350. For example, the system may input the augmented prompt to the AI model 348 (e.g., as a set of vectors or values indicating the query 304 and the information determined based on the ensemble RAG 336, the graph RAG 338, the vector RAG 340, or any combination thereof), and the AI model may output, in response to the augmented prompt, the response 350 (e.g., a set of vectors or values indicating the response 350). The response 350 may be an answer to the question posed by the query 304. The QA system may send the response 350 or an indication of the response 350 to a user as an answer (which may or may not be further modified). For example, the QA system may send the response 350 back to the user device 302 in response to the query 304, and the user device 302 may present the response 350 to the user via a user interface. Thus, the augmented prompt may support “grounding” the query 304 to a knowledge base (e.g., the knowledge base represented by vectors and triplets generated as described with reference to FIG. 2), which may support an improved prompt and more relevant, accurate, and user acceptable results from the LLM (e.g., the AI model 348).

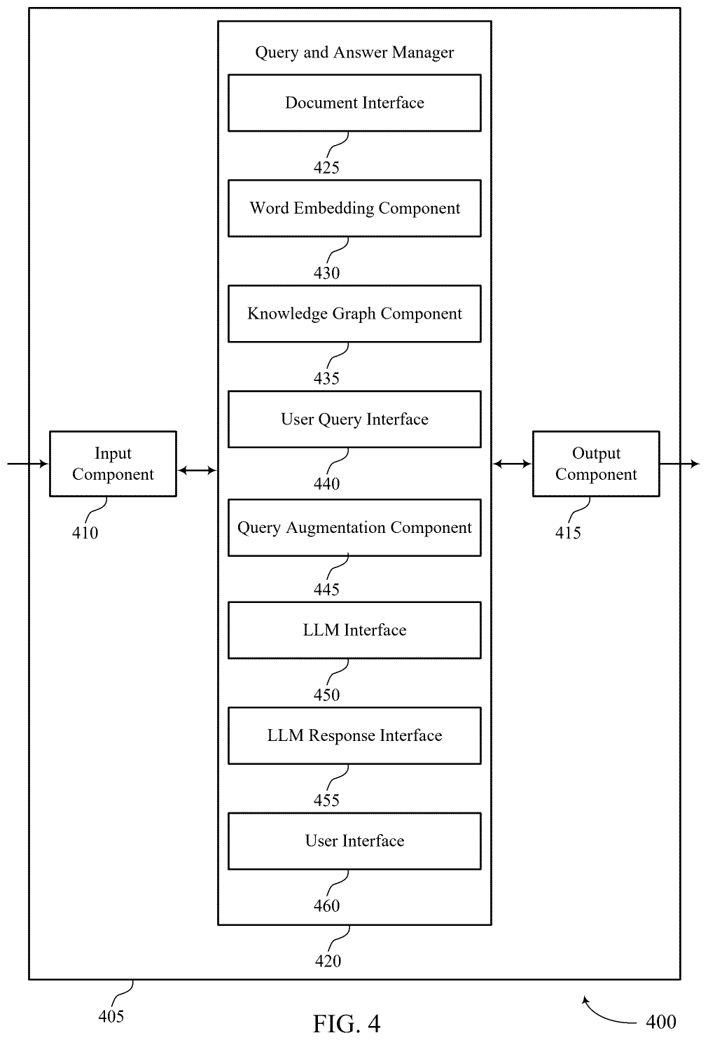

FIG. 4 shows a block diagram 400 of a device 405 that supports an ensemble of vector and graph based embeddings for large language prompt augmentation in accordance with aspects of the present disclosure. The device 405 may be a processing device or system, such as a server, a server cluster, a database server, an application server, a worker server, a cloud-based server or component, a user device, a virtual service, or any combination of these or other devices that support augmenting and processing a query using AI techniques. The device 405 may include an input component 410, an output component 415, and a query and answer manager 420. The device 405, or one or more components of the device 405 (e.g., the input component 410, the output component 415, the query and answer manager 420), may include at least one processor, which may be coupled with at least one memory, to support the described techniques. Each of these components may be in communication with one another (e.g., via one or more buses).

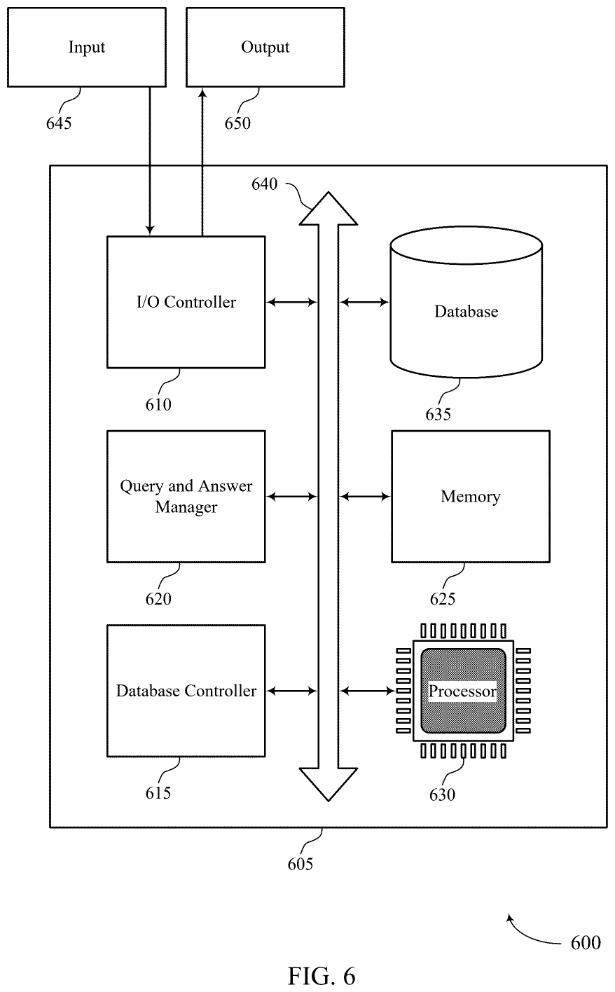

The input component 410 may manage input signals for the device 405. For example, the input component 410 may identify input signals based on an interaction with a modem, a keyboard, a mouse, a touchscreen, or a similar device. These input signals may be associated with user input or processing at other components or devices. In some cases, the input component 410 may utilize an operating system such as iOS®, ANDROID®, MS-DOS®, MS-WINDOWS®, OS/2®, UNIX®, LINUX®, or another known operating system to handle input signals. The input component 410 may send aspects of these input signals to other components of the device 405 for processing. For example, the input component 410 may transmit input signals to the query and answer manager 420 to support an ensemble of vector and graph based embeddings for large language prompt augmentation. In some cases, the input component 410 may be a component of an input/output (I/O) controller 610 as described with reference to FIG. 6.

The output component 415 may manage output signals for the device 405. For example, the output component 415 may receive signals from other components of the device 405, such as the query and answer manager 420, and may transmit these signals to other components or devices. In some examples, the output component 415 may transmit output signals for display in a user interface, for storage in a database or data store, for further processing at a server or server cluster, or for any other processes at any number of devices or systems. In some cases, the output component 415 may be a component of an I/O controller 610 as described with reference to FIG. 6.

For example, the query and answer manager 420 may include a document interface 425, a word embedding component 430, a knowledge graph component 435, a user query interface 440, a query augmentation component 445, an LLM interface 450, an LLM response interface 455, a user interface 460, or any combination thereof. In some examples, the query and answer manager 420, or various components thereof, may be configured to perform various operations (e.g., receiving, monitoring, transmitting) using or otherwise in cooperation with the input component 410, the output component 415, or both. For example, the query and answer manager 420 may receive information from the input component 410, send information to the output component 415, or be integrated in combination with the input component 410, the output component 415, or both to receive information, transmit information, or perform various other operations as described herein.

The query and answer manager 420 may support data processing in accordance with examples as disclosed herein. The document interface 425 may be configured to support obtaining a set of multiple documents for input into a query response system. The word embedding component 430 may be configured to support generating a set of vector embeddings based on the set of multiple documents and using a semantic vector augmentation pipeline. The knowledge graph component 435 may be configured to support generating a set of knowledge graphs based on the set of multiple documents and using a knowledge graph augmentation pipeline, where each knowledge graph of the set of knowledge graphs includes a set of multiple knowledge graph triplets. The user query interface 440 may be configured to support obtaining, at the query response system, a user query. The query augmentation component 445 may be configured to support augmenting the user query to generate an augmented prompt using at least one or more vector embeddings from the set of vector embeddings and using one or more knowledge graph triplets from the set of knowledge graphs. The LLM interface 450 may be configured to support providing, to an LLM, the augmented prompt. The LLM response interface 455 may be configured to support obtaining, from the LLM, a response to the augmented prompt. The user interface 460 may be configured to support outputting the response to the augmented prompt as an answer to the user query.

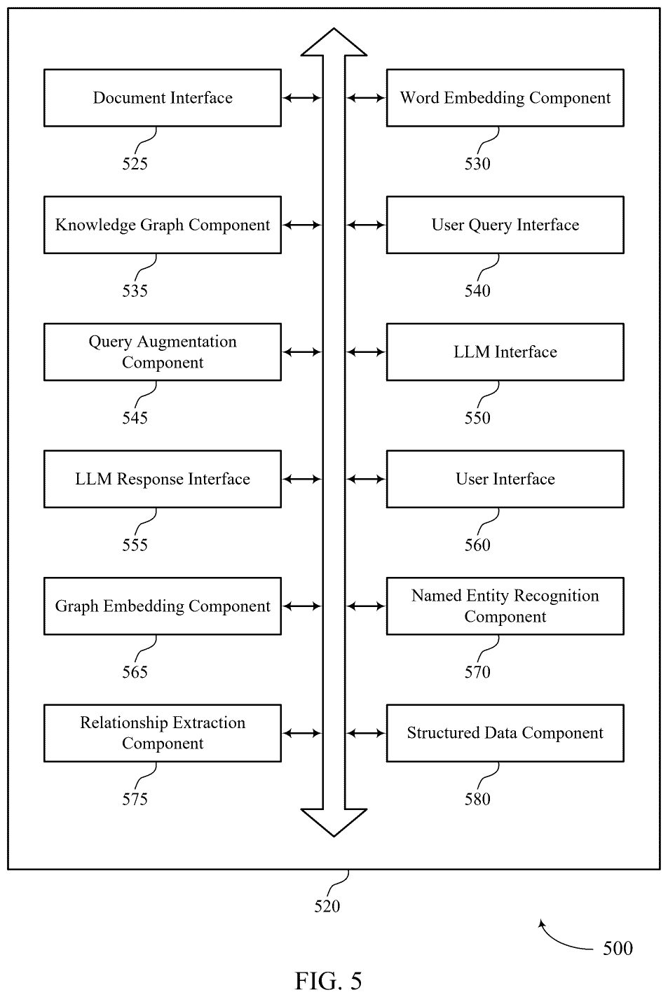

FIG. 5 shows a block diagram 500 of a query and answer manager 520 that supports an ensemble of vector and graph based embeddings for large language prompt augmentation in accordance with aspects of the present disclosure. The query and answer manager 520 may be an example of aspects of a query and answer manager 420 as described herein. The query and answer manager 520, or various components thereof, may be an example of means for performing various aspects of vector and graph based embeddings for large language prompt augmentation as described herein. For example, the query and answer manager 520 may include a document interface 525, a word embedding component 530, a knowledge graph component 535, a user query interface 540, a query augmentation component 545, an LLM interface 550, an LLM response interface 555, a user interface 560, a graph embedding component 565, a named entity recognition component 570, a relationship extraction component 575, a structured data component 580, or any combination thereof. Each of these components, or components of subcomponents thereof (e.g., one or more processors, one or more memories), may communicate, directly or indirectly, with one another (e.g., via one or more buses).

The query and answer manager 520 may support data processing in accordance with examples as disclosed herein. The document interface 525 may be configured to support obtaining a set of multiple documents for input into a query response system. The word embedding component 530 may be configured to support generating a set of vector embeddings based on the set of multiple documents and a semantic vector augmentation pipeline. The knowledge graph component 535 may be configured to support generating a set of knowledge graphs based on the set of multiple documents and a knowledge graph augmentation pipeline, where a knowledge graph of the set of knowledge graphs includes a respective set of multiple knowledge graph triplets. The user query interface 540 may be configured to support obtaining, at the query response system, a user query. The query augmentation component 545 may be configured to support augmenting the user query to generate an augmented prompt based on one or more vector embeddings from the set of vector embeddings and one or more knowledge graph triplets from the set of knowledge graphs. The LLM interface 550 may be configured to support providing, as an input to an LLM, the augmented prompt. The LLM response interface 555 may be configured to support the LLM outputting a response to the augmented prompt. The user interface 560 may be configured to support outputting an indication of the response to the augmented prompt as an answer to the user query.

In some examples, the graph embedding component 565 may be configured to support generating a set of graph embeddings based on the set of knowledge graphs, a set of structured data, or both. In some examples, the query augmentation component 545 may be configured to support augmenting the user query based on one or more graph embeddings from the set of graph embeddings.

In some examples, to support generating the set of knowledge graphs, the named entity recognition component 570 may be configured to support determining a set of multiple named entities from the set of multiple documents. In some examples, to support generating the set of knowledge graphs, the relationship extraction component 575 may be configured to support determining a relationship between a first named entity and a second named entity of the set of multiple named entities based on the set of multiple documents. In some examples, the knowledge graph component 535 may be configured to support generating a knowledge graph triplet that indicates the first named entity, the relationship, and the second named entity.

In some examples, to support determining the set of multiple named entities, the named entity recognition component 570 may be configured to support performing coreference resolution to replace, in a document of the plurality of documents, a reference to a named entity with the named entity.

In some examples, the set of multiple documents includes one or more websites, one or more RSS feed objects, one or more communication platform feeds, or a combination thereof.

In some examples, the set of multiple documents includes public unstructured data, private unstructured data, or both.

In some examples, the structured data component 580 may be configured to support obtaining a set of structured data. In some examples, the structured data component 580 may be configured to support extracting a set of entities from the set of structured data. In some examples, the structured data component 580 may be configured to support performing entity resolution for one or more entities in the knowledge graph augmentation pipeline based on the set of entities extracted from the set of structured data.

In some examples, the set of knowledge graphs includes one or more nodes, one or more edges, or both that are associated with respective timestamps, where augmenting the user query is further based on the respective timestamps.

In some examples, the query augmentation component 545 may be configured to support determining that a timestamp indicates that a corresponding knowledge graph triplet is expired and refraining from augmenting the user query with the corresponding knowledge graph triplet based at least in part on the timestamp.

FIG. 6 shows a diagram of a system 600 including a device 605 that supports an ensemble of vector and graph based embeddings for large language prompt augmentation in accordance with aspects of the present disclosure. The device 605 may be an example of or include components of a device 405 as described herein. The device 605 may include components for bi-directional data communications including components for transmitting and receiving communications, such as a query and answer manager 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In some other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In some other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In some other cases, a memory controller may be integrated into the processor 630. The processor 630 may be configured to execute computer-readable instructions stored in at least one memory 625 to perform various functions (e.g., functions or tasks supporting an ensemble of vector and graph based embeddings for large language prompt augmentation). The processor 630 may be an example of a single processor or multiple processors. For example, the device 605 may include one or more processors 630.

The query and answer manager 620 may support data processing in accordance with examples as disclosed herein. For example, the query and answer manager 620 may be configured to support obtaining a set of multiple documents for input into a query response system. The query and answer manager 620 may be configured to support generating a set of vector embeddings based on the set of multiple documents and a semantic vector augmentation pipeline. The query and answer manager 620 may be configured to support generating a set of knowledge graphs based on the set of multiple documents and a knowledge graph augmentation pipeline, where each knowledge graph of the set of knowledge graphs includes a respective set of multiple knowledge graph triplets. The query and answer manager 620 may be configured to support obtaining, at the query response system, a user query. The query and answer manager 620 may be configured to support augmenting the user query to generate an augmented prompt based on one or more vector embeddings from the set of vector embeddings and one or more knowledge graph triplets from the set of knowledge graphs. The query and answer manager 620 may be configured to support providing, as an input to an LLM, the augmented prompt, where the LLM outputs a response to the augmented prompt. The query and answer manager 620 may be configured to support outputting an indication of the response to the augmented prompt as an answer to the user query.

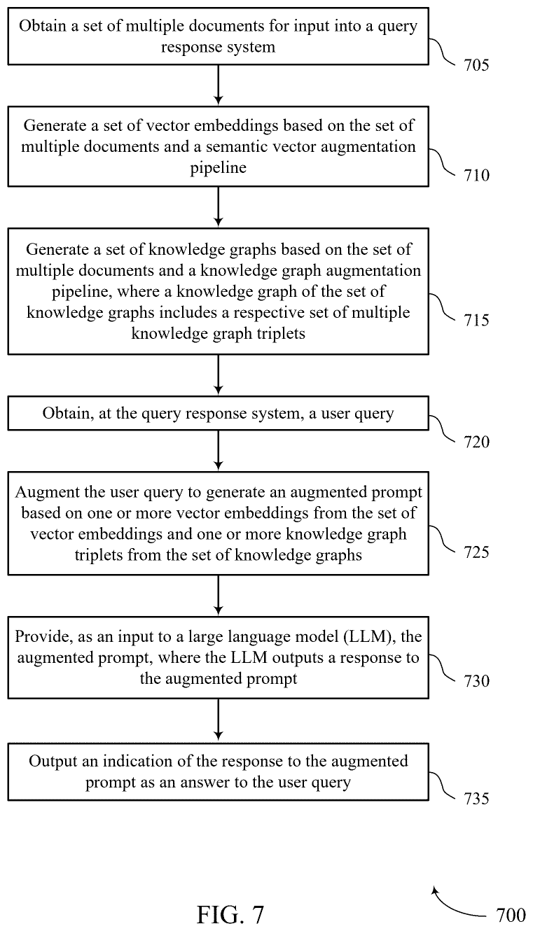

FIG. 7 shows a flowchart illustrating a method 700 that supports an ensemble of vector and graph based embeddings for large language prompt augmentation in accordance with aspects of the present disclosure. The operations of the method 700 may be implemented by a processing device or system or components thereof as described herein. For example, the operations of the method 700 may be performed by a server, worker server, application server, database server, server cluster, user device, cloud-based service, container, virtual server, or any combination of these or other devices or systems that support data processing as described with reference to FIGS. 1 through 6. In some examples, a processing device or system may execute a set of instructions to control functional elements to perform the described functions. Additionally, or alternatively, the processing device or system may perform aspects of the described functions using special-purpose hardware.

At 705, the method may include obtaining a set of multiple documents for input into a query response system. The operations of 705 may be performed in accordance with examples as disclosed herein. In some examples, aspects of the operations of 705 may be performed by a document interface 525 as described with reference to FIG. 5.

At 710, the method may include generating a set of vector embeddings based on the set of multiple documents and a semantic vector augmentation pipeline. The operations of 710 may be performed in accordance with examples as disclosed herein. In some examples, aspects of the operations of 710 may be performed by a word embedding component 530 as described with reference to FIG. 5.

At 715, the method may include generating a set of knowledge graphs based on the set of multiple documents and a knowledge graph augmentation pipeline, where a knowledge graph of the set of knowledge graphs includes a respective set of multiple knowledge graph triplets. The operations of 715 may be performed in accordance with examples as disclosed herein. In some examples, aspects of the operations of 715 may be performed by a knowledge graph component 535 as described with reference to FIG. 5.

At 720, the method may include obtaining, at the query response system, a user query. The operations of 720 may be performed in accordance with examples as disclosed herein. In some examples, aspects of the operations of 720 may be performed by a user query interface 540 as described with reference to FIG. 5.

At 725, the method may include augmenting the user query to generate an augmented prompt based on one or more vector embeddings from the set of vector embeddings and one or more knowledge graph triplets from the set of knowledge graphs. The operations of 725 may be performed in accordance with examples as disclosed herein. In some examples, aspects of the operations of 725 may be performed by a query augmentation component 545 as described with reference to FIG. 5.

At 730, the method may include providing, as an input to an LLM, the augmented prompt, where the LLM outputs a response to the augmented prompt. The operations of 730 may be performed in accordance with examples as disclosed herein. In some examples, aspects of the operations of 730 may be performed by an LLM interface 550 as described with reference to FIG. 5.

At 735, the method may include outputting an indication of the response to the augmented prompt as an answer to the user query. The operations of 735 may be performed in accordance with examples as disclosed herein. In some examples, aspects of the operations of 735 may be performed by a user interface 560 as described with reference to FIG. 5.

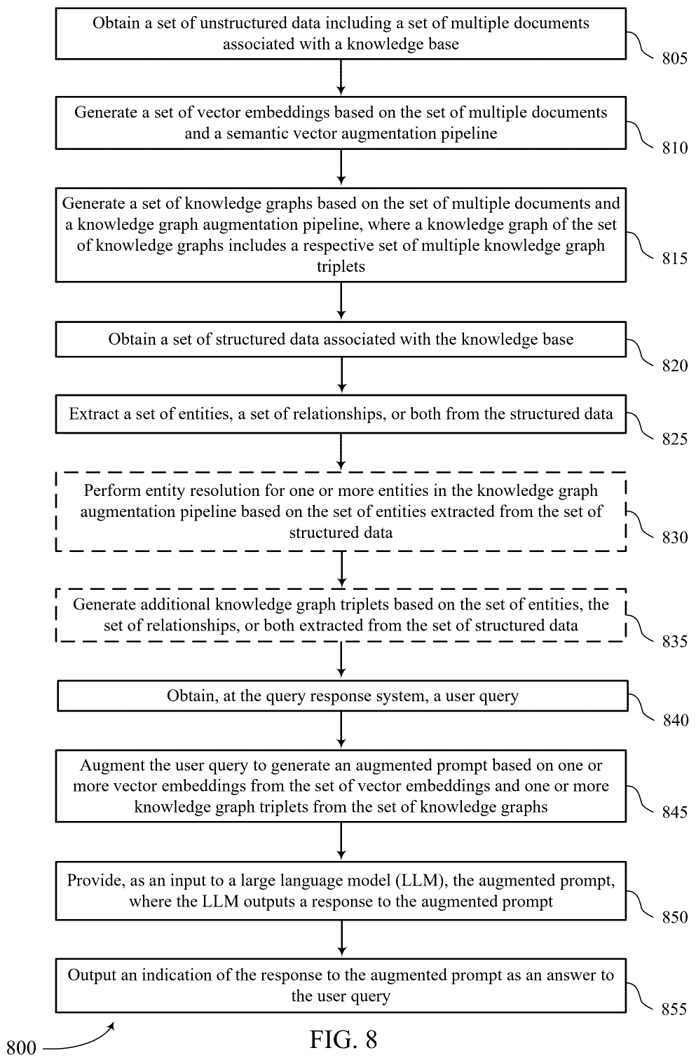

FIG. 8 shows a flowchart illustrating a method 800 that supports an ensemble of vector and graph based embeddings for large language prompt augmentation in accordance with aspects of the present disclosure. The operations of the method 800 may be implemented by a processing device or system or components thereof as described herein. For example, the operations of the method 800 may be performed by a server, worker server, application server, database server, server cluster, user device, cloud-based service, container, virtual server, or any combination of these or other devices or systems that support data processing as described with reference to FIGS. 1 through 6. In some examples, a processing device or system may execute a set of instructions to control functional elements to perform the described functions. Additionally, or alternatively, the processing device or system may perform aspects of the described functions using special-purpose hardware.

At 805, the method may include obtaining a set of unstructured data including a set of multiple documents associated with a knowledge base. The operations of 805 may be performed in accordance with examples as disclosed herein. In some examples, aspects of the operations of 805 may be performed by a document interface 525 as described with reference to FIG. 5.

At 810, the method may include generating a set of vector embeddings based on the set of multiple documents and a semantic vector augmentation pipeline. The operations of 810 may be performed in accordance with examples as disclosed herein. In some examples, aspects of the operations of 810 may be performed by a word embedding component 530 as described with reference to FIG. 5.

At 815, the method may include generating a set of knowledge graphs based on the set of multiple documents and a knowledge graph augmentation pipeline, where a knowledge graph of the set of knowledge graphs includes a set of multiple knowledge graph triplets. The operations of 815 may be performed in accordance with examples as disclosed herein. In some examples, aspects of the operations of 815 may be performed by a knowledge graph component 535 as described with reference to FIG. 5.

At 820, the method may include obtaining a set of structured data associated with the knowledge base. The operations of 820 may be performed in accordance with examples as disclosed herein. In some examples, aspects of the operations of 820 may be performed by a structured data component 580 as described with reference to FIG. 5.

At 825, the method may include extracting a set of entities (e.g., named entities), a set of relationships, or both from the structured data. The operations of 825 may be performed in accordance with examples as disclosed herein. In some examples, aspects of the operations of 825 may be performed by a named entity recognition component 570, a relationship extraction component 575, or both as described with reference to FIG. 5.

In some examples, at 830, the method may include performing entity resolution for one or more entities in the knowledge graph augmentation pipeline based on the set of entities extracted from the set of structured data. The operations of 830 may be performed in accordance with examples as disclosed herein. In some examples, aspects of the operations of 830 may be performed by a knowledge graph component 535 as described with reference to FIG. 5.

In some examples, at 835, the method may include generating additional knowledge graph triplets based on the set of entities, the set of relationships, or both extracted from the set of structured data. The operations of 835 may be performed in accordance with examples as disclosed herein. In some examples, aspects of the operations of 835 may be performed by a knowledge graph component 535 as described with reference to FIG. 5.

At 840, the method may include obtaining, at the query response system, a user query. The operations of 840 may be performed in accordance with examples as disclosed herein. In some examples, aspects of the operations of 840 may be performed by a user query interface 540 as described with reference to FIG. 5.

At 845, the method may include augmenting the user query to generate an augmented prompt based on one or more vector embeddings from the set of vector embeddings and one or more knowledge graph triplets from the set of knowledge graphs. The operations of 845 may be performed in accordance with examples as disclosed herein. In some examples, aspects of the operations of 845 may be performed by a query augmentation component 545 as described with reference to FIG. 5.

At 850, the method may include providing, as an input to an LLM, the augmented prompt, where the LLM outputs a response to the augmented prompt. The operations of 850 may be performed in accordance with examples as disclosed herein. In some examples, aspects of the operations of 850 may be performed by an LLM interface 550 as described with reference to FIG. 5.

At 855, the method may include outputting an indication of the response to the augmented prompt as an answer to the user query. The operations of 855 may be performed in accordance with examples as disclosed herein. In some examples, aspects of the operations of 855 may be performed by a user interface 560 as described with reference to FIG. 5.

A method for data processing (e.g., by an apparatus) is described. The method may include obtaining a set of multiple documents for input into a query response system, generating a set of vector embeddings based on the set of multiple documents and a semantic vector augmentation pipeline, generating a set of knowledge graphs based on the set of multiple documents and a knowledge graph augmentation pipeline, where a knowledge graph of the set of knowledge graphs includes a respective set of multiple knowledge graph triplets, obtaining, at the query response system, a user query, augmenting the user query to generate an augmented prompt based on one or more vector embeddings from the set of vector embeddings and one or more knowledge graph triplets from the set of knowledge graphs, providing, as an input to an LLM, the augmented prompt, where the LLM outputs a response to the augmented prompt, and outputting an indication of the response to the augmented prompt as an answer to the user query.

An apparatus for data processing is described. The apparatus may include one or more memories storing processor-executable code and one or more processors coupled with the one or more memories. The one or more processors may individually or collectively be operable to execute the code to cause the apparatus to obtain a set of multiple documents for input into a query response system, generate a set of vector embeddings based on the set of multiple documents and a semantic vector augmentation pipeline, generate a set of knowledge graphs based on the set of multiple documents and a knowledge graph augmentation pipeline, where a knowledge graph of the set of knowledge graphs includes a respective set of multiple knowledge graph triplets, obtain, at the query response system, a user query, augment the user query to generate an augmented prompt based on one or more vector embeddings from the set of vector embeddings and one or more knowledge graph triplets from the set of knowledge graphs, provide, as an input to an LLM, the augmented prompt, where the LLM outputs a response to the augmented prompt, and output an indication of the response to the augmented prompt as an answer to the user query.

Another apparatus for data processing is described. The apparatus may include means for obtaining a set of multiple documents for input into a query response system, means for generating a set of vector embeddings based on the set of multiple documents and a semantic vector augmentation pipeline, means for generating a set of knowledge graphs based on the set of multiple documents and a knowledge graph augmentation pipeline, where a knowledge graph of the set of knowledge graphs includes a respective set of multiple knowledge graph triplets, means for obtaining, at the query response system, a user query, means for augmenting the user query to generate an augmented prompt based on one or more vector embeddings from the set of vector embeddings and one or more knowledge graph triplets from the set of knowledge graphs, means for providing, as an input to an LLM, the augmented prompt, where the LLM outputs a response to the augmented prompt, and means for outputting an indication of the response to the augmented prompt as an answer to the user query.

A non-transitory computer-readable medium storing code for data processing is described. The code may include instructions executable by one or more processors to obtain a set of multiple documents for input into a query response system, generate a set of vector embeddings based on the set of multiple documents and a semantic vector augmentation pipeline, generate a set of knowledge graphs based on the set of multiple documents and a knowledge graph augmentation pipeline, where a knowledge graph of the set of knowledge graphs includes a respective set of multiple knowledge graph triplets, obtain, at the query response system, a user query, augment the user query to generate an augmented prompt based on one or more vector embeddings from the set of vector embeddings and one or more knowledge graph triplets from the set of knowledge graphs, provide, as an input to an LLM, the augmented prompt, where the LLM outputs a response to the augmented prompt, and output an indication of the response to the augmented prompt as an answer to the user query.

Some examples of the method, apparatus, and non-transitory computer-readable medium described herein may further include operations, features, means, or instructions for generating a set of graph embeddings based on from the set of knowledge graphs, a set of structured data, or both and augmenting the user query based on one or more graph embeddings from the set of graph embeddings.

In some examples of the method, apparatus, and non-transitory computer-readable medium described herein, generating the set of knowledge graphs may include operations, features, means, or instructions for determining a set of multiple named entities from the set of multiple documents, determining a relationship between a first named entity and a second named entity of the set of multiple named entities based on the set of multiple documents, and generating a knowledge graph triplet that indicates the first named entity, the relationship, and the second named entity. In some examples of the method, apparatus, and non-transitory computer-readable medium described herein, determining the set of multiple named entities may include operations, features, means, or instructions for performing coreference resolution to replace, in a document of the set of multiple documents, a reference to a named entity with the named entity.

In some examples of the method, apparatus, and non-transitory computer-readable medium described herein, the set of multiple documents includes one or more websites, one or more RSS feed objects, one or more communication platform feeds, or a combination thereof.

In some examples of the method, apparatus, and non-transitory computer-readable medium described herein, the set of multiple documents may include public unstructured data, private unstructured data, or both.

Some examples of the method, apparatus, and non-transitory computer-readable medium described herein may further include operations, features, means, or instructions for obtaining a set of structured data, extracting a set of entities from the set of structured data, and performing entity resolution for one or more entities in the knowledge graph augmentation pipeline based on the set of entities extracted from the set of structured data.

In some examples of the method, apparatus, and non-transitory computer-readable medium described herein, the set of knowledge graphs may include one or more nodes, one or more edges, or both that may be associated with respective timestamps, where augmenting the user query may be further based on the respective timestamps.

Some examples of the method, apparatus, and non-transitory computer-readable medium described herein may further include operations, features, means, or instructions for determining that a timestamp indicates that a corresponding knowledge graph triplet is expired and refraining from augmenting the user query with the corresponding knowledge graph triplet based on the timestamp.

The following provides an overview of aspects of the present disclosure:

Aspect 1: A method for data processing, comprising: obtaining a plurality of documents for input into a query response system; generating a set of vector embeddings based at least in part on the plurality of documents and a semantic vector augmentation pipeline; generating a set of knowledge graphs based at least in part on the plurality of documents and a knowledge graph augmentation pipeline, wherein a knowledge graph of the set of knowledge graphs comprises a respective plurality of knowledge graph triplets; obtaining, at the query response system, a user query; augmenting the user query to generate an augmented prompt based at least in part on one or more vector embeddings from the set of vector embeddings and one or more knowledge graph triplets from the set of knowledge graphs; providing, as an input to an LLM, the augmented prompt, where the LLM outputs a response to the augmented prompt; and outputting an indication of the response to the augmented prompt as an answer to the user query.

Aspect 2: The method of aspect 1, further comprising: generating a set of graph embeddings based at least in part on the set of knowledge graphs, a set of structured data, or both; and augmenting the user query based at least in part on one or more graph embeddings from the set of graph embeddings.

Aspect 3: The method of either of aspects 1 or 2, wherein generating the set of knowledge graphs comprises: determining a plurality of named entities from the plurality of documents; determining a relationship between a first named entity and a second named entity of the plurality of named entities based at least in part on the plurality of documents; and generating a knowledge graph triplet that indicates the first named entity, the relationship, and the second named entity.

Aspect 4: The method of aspect 3, wherein determining the plurality of named entities comprises: performing coreference resolution to replace, in a document of the plurality of documents, a reference to a named entity with the named entity.

Aspect 5: The method of any of aspects 1 through 4, wherein the plurality of documents comprises one or more websites, one or more RSS feed objects, one or more communication platform feeds, or a combination thereof.

Aspect 6: The method of any of aspects 1 through 5, wherein the plurality of documents comprises public unstructured data, private unstructured data, or both.

Aspect 7: The method of any of aspects 1 through 6, further comprising: obtaining a set of structured data; extracting a set of entities from the set of structured data; and performing entity resolution for one or more entities in the knowledge graph augmentation pipeline based at least in part on the set of entities extracted from the set of structured data.

Aspect 8: The method of any of aspects 1 through 7, wherein the set of knowledge graphs comprises one or more nodes, one or more edges, or both that are associated with respective timestamps, and wherein augmenting the user query is further based at least in part on the respective timestamps.

Aspect 9: The method of aspect 8, further comprising: determining that a timestamp indicates that a corresponding knowledge graph triplet is expired; and refraining from augmenting the user query with the corresponding knowledge graph triplet based at least in part on the timestamp.

Aspect 10: An apparatus for data processing, comprising one or more memories storing processor-executable code, and one or more processors coupled with the one or more memories and individually or collectively operable to execute the code to cause the apparatus to perform a method of any of aspects 1 through 9.

Aspect 11: An apparatus for data processing, comprising at least one means for performing a method of any of aspects 1 through 9.

Aspect 12: A non-transitory computer-readable medium storing code for data processing, the code comprising instructions executable by one or more processors to perform a method of any of aspects 1 through 9.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for data processing, comprising:
obtaining a plurality of documents for input into a query response system;
generating a set of vector embeddings based at least in part on the plurality of documents and a semantic vector augmentation pipeline;
generating a set of knowledge graphs based at least in part on the plurality of documents and a knowledge graph augmentation pipeline, wherein a knowledge graph of the set of knowledge graphs comprises a respective plurality of knowledge graph triplets;
obtaining, at the query response system, a user query;
augmenting the user query to generate an augmented prompt based at least in part on one or more vector embeddings from the set of vector embeddings and one or more knowledge graph triplets from the set of knowledge graphs;
providing, as an input to a large language model (LLM), the augmented prompt, wherein the LLM outputs a response to the augmented prompt; and
outputting an indication of the response to the augmented prompt as an answer to the user query.

2. The method of claim 1, further comprising:
generating a set of graph embeddings based at least in part on the set of knowledge graphs, a set of structured data, or both; and
augmenting the user query based at least in part on one or more graph embeddings from the set of graph embeddings.

3. The method of claim 1, wherein generating the set of knowledge graphs comprises:
determining a plurality of named entities from the plurality of documents;
determining a relationship between a first named entity and a second named entity of the plurality of named entities based at least in part on the plurality of documents; and
generating a knowledge graph triplet that indicates the first named entity, the relationship, and the second named entity.

4. The method of claim 3, wherein determining the plurality of named entities comprises:
performing coreference resolution to replace, in a document of the plurality of documents, a reference to a named entity with the named entity.

5. The method of claim 1, wherein the plurality of documents comprises one or more websites, one or more Really Simple Syndication (RSS) feed objects, one or more communication platform feeds, or a combination thereof.

6. The method of claim 1, wherein the plurality of documents comprises public unstructured data, private unstructured data, or both.

7. The method of claim 1, further comprising:
obtaining a set of structured data;
extracting a set of entities from the set of structured data; and
performing entity resolution for one or more entities in the knowledge graph augmentation pipeline based at least in part on the set of entities extracted from the set of structured data.

8. The method of claim 1, wherein the set of knowledge graphs comprises one or more nodes, one or more edges, or both that are associated with respective timestamps, and wherein augmenting the user query is further based at least in part on the respective timestamps.

9. The method of claim 8, further comprising:
determining that a timestamp indicates that a corresponding knowledge graph triplet is expired; and
refraining from augmenting the user query with the corresponding knowledge graph triplet based at least in part on the timestamp.

10. An apparatus for data processing, comprising:
one or more memories storing processor-executable code; and
one or more processors coupled with the one or more memories and individually or collectively operable to execute the code to cause the apparatus to:
obtain a plurality of documents for input into a query response system;
generate a set of vector embeddings based at least in part on the plurality of documents and a semantic vector augmentation pipeline;
generate a set of knowledge graphs based at least in part on the plurality of documents and a knowledge graph augmentation pipeline, wherein a knowledge graph of the set of knowledge graphs comprises a respective plurality of knowledge graph triplets;
obtain, at the query response system, a user query;
augment the user query to generate an augmented prompt based at least in part on one or more vector embeddings from the set of vector embeddings and one or more knowledge graph triplets from the set of knowledge graphs;
provide, as an input to a large language model (LLM), the augmented prompt, wherein the LLM outputs a response to the augmented prompt; and
output an indication of the response to the augmented prompt as an answer to the user query.

11. The apparatus of claim 10, wherein the one or more processors are individually or collectively further operable to execute the code to cause the apparatus to:
generate a set of graph embeddings based at least in part on the set of knowledge graphs, a set of structured data, or both; and
augment the user query based at least in part on one or more graph embeddings from the set of graph embeddings.

12. The apparatus of claim 10, wherein, to generate the set of knowledge graphs, the one or more processors are individually or collectively operable to execute the code to cause the apparatus to:
determine a plurality of named entities from the plurality of documents;
determine a relationship between a first named entity and a second named entity of the plurality of named entities based at least in part on the plurality of documents; and
generate a knowledge graph triplet that indicates the first named entity, the relationship, and the second named entity.

13. The apparatus of claim 12, wherein, to determine the plurality of named entities, the one or more processors are individually or collectively operable to execute the code to cause the apparatus to:
perform coreference resolution to replace, in a document of the plurality of documents, a reference to a named entity with the named entity.

14. The apparatus of claim 10, wherein the plurality of documents comprises one or more websites, one or more Really Simple Syndication (RSS) feed objects, one or more communication platform feeds, or a combination thereof.

15. The apparatus of claim 10, wherein the plurality of documents comprises public unstructured data, private unstructured data, or both.

16. The apparatus of claim 10, wherein the one or more processors are individually or collectively further operable to execute the code to cause the apparatus to:
obtain a set of structured data;
extract a set of entities from the set of structured data; and
perform entity resolution for one or more entities in the knowledge graph augmentation pipeline based at least in part on the set of entities extracted from the set of structured data.

17. The apparatus of claim 10, wherein the set of knowledge graphs comprises one or more nodes, one or more edges, or both that are associated with respective timestamps, and wherein augmenting the user query is further based at least in part on the respective timestamps.

18. The apparatus of claim 17, wherein the one or more processors are individually or collectively further operable to execute the code to cause the apparatus to:
determine that a timestamp indicates that a corresponding knowledge graph triplet is expired; and
refrain from augmenting the user query with the corresponding knowledge graph triplet based at least in part on the timestamp.

19. A non-transitory computer-readable medium storing code for data processing, the code comprising instructions executable by one or more processors to:
obtain a plurality of documents for input into a query response system;
generate a set of vector embeddings based at least in part on the plurality of documents and a semantic vector augmentation pipeline;
generate a set of knowledge graphs based at least in part on the plurality of documents and a knowledge graph augmentation pipeline, wherein a knowledge graph of the set of knowledge graphs comprises a respective plurality of knowledge graph triplets;
obtain, at the query response system, a user query;
augment the user query to generate an augmented prompt based at least in part on one or more vector embeddings from the set of vector embeddings and one or more knowledge graph triplets from the set of knowledge graphs;
provide, as an input to a large language model (LLM), the augmented prompt, wherein the LLM outputs a response to the augmented prompt; and
output an indication of the response to the augmented prompt as an answer to the user query.

20. The non-transitory computer-readable medium of claim 19, wherein the instructions are further executable by the one or more processors to:
generate a set of graph embeddings based at least in part on the set of knowledge graphs, a set of structured data, or both; and
augment the user query based at least in part on one or more graph embeddings from the set of graph embeddings.
